(19) United States
(12) Patent Application Publication
(10) Pub. No.: US 2006/0020670 A1
(43) Pub. Date: Jan. 26, 2006

(54) Computer system that facilitates addition of webpages to website

(76) Inventor: Nathan Anderson, Stamford, CT (US)

Correspondence Address: Buckley, Maschoff & Talwalker LLC, Five Elm Street, New Canaan, CT, 06840, US

(21) Appl. No.: 10/899,440

(22) Filed: Jul. 26, 2004

(51) Int. Cl. G06F 15/16

(52) U.S. Cl. 709/206

(57) ABSTRACT

A computer system includes a server computer, a plurality of client computers and a communication network that interconnects the server computer and the client computers. The server computer hosts one or more websites. Content for a proposed new webpage may be sent from a user of a client computer to the server computer as an attachment to an electronic mail message. The server sends a follow-up e-mail message to the client computer to confirm the user's identity and to allow the user to enter indexing information.

### FIELD

The present invention relates to computer systems, and more particularly to computer systems in which websites are hosted and updated.

### BACKGROUND

It is common for corporations or other organizations to maintain a server computer (directly or via a web-hosting contractor) to host a website or websites for use by employees of the organization. Ideally such websites may serve as a clearing house and central resource for information concerning the business of the organization. The website may be accessed by individual employees via their desktop or laptop computers and via an intranet or other data communication network.

For a corporate website to fully achieve its potential as an information resource, it may be desirable for a large number of the employees to be able to add information to the website. However, conventional web-authoring tools and practices may present significant technical and practical barriers to allowing employees to contribute content to the website. One concern may be security: the corporate employees with ultimate responsibility for the website will generally want to be sure that only authorized employees—and not outsiders or “spoofers”—are able to add content to the website. On the other hand, it would be best if authorized employees were able to add content to the website in a convenient manner, and without needing extensive training.

### SUMMARY

To alleviate problems inherent in the prior art, the present invention introduces improved computer systems and methods for operating computer systems to facilitate adding content to a website by a wide range of users.

According to one embodiment, a method includes receiving at a server computer a first electronic mail message with an attachment attached to the electronic mail message. The first electronic mail message was sent by a sender. The method also includes automatically responding to the first electronic mail message by sending to the sender from the server computer a second electronic mail message, which includes a form to be completed by the sender. The method further includes receiving from the sender a third electronic mail message which includes the completed form, and automatically responding to the third electronic mail message by adding the attachment as a webpage that is part of a website maintained by the server computer.

According to another embodiment, a method includes receiving at a server computer a first electronic mail message with an attachment attached to the electronic mail message. The first electronic mail message was sent by a sender. The method also includes automatically responding to the first electronic mail message by sending to the sender from the server computer a second electronic mail message, which includes a hyperlink. The method further includes receiving an indication that the sender has actuated the hyperlink, and, in response to the indication, downloading a first webpage to the sender. The first webpage includes a form to be completed by the sender. In addition, the method includes receiving indexing information entered into the form by the sender, and automatically responding to the received indexing information by adding the attachment as a second webpage that is part of a website maintained by the server computer.

According to still another embodiment, a method includes receiving at a server computer an electronic mail message with an attachment attached to the electronic mail message. The electronic mail message was sent by a sender and includes indexing information. At least part of the electronic mail message and/or the attachment is encrypted. The method also includes automatically responding to the electronic mail message by decrypting the encrypted portion of the electronic mail message or attachment. The method further includes determining whether the decrypting was successful. If so, the method includes automatically adding the attachment as a webpage that is part of a website maintained by the server computer.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram of a computer system according to some embodiments.

FIG. 2 is a block diagram of a server computer that is part of the computer system of FIG. 1.

FIG. 3 is a block diagram of a typical one of the client computers that are part of the computer system of FIG. 1.

FIG. 4 is a flow chart that illustrates a procedure performed according to some embodiments at one of the client computers to add a webpage to a website maintained on the server computer.

FIGS. 5-8 are examples of screen displays that may be displayed by one of the client computers of the computer system of FIG. 1 in connection with the process illustrated in FIG. 4.

FIGS. 9A and 9B together form a flow chart that illustrates a process performed according to some embodiments by the server computer to add a webpage to the website maintained on the server computer.

FIG. 10 is a flow chart that illustrates an alternative process performed according to some embodiments by the server computer to add a webpage to the website maintained on the server computer.

### DETAILED DESCRIPTION

System Overview

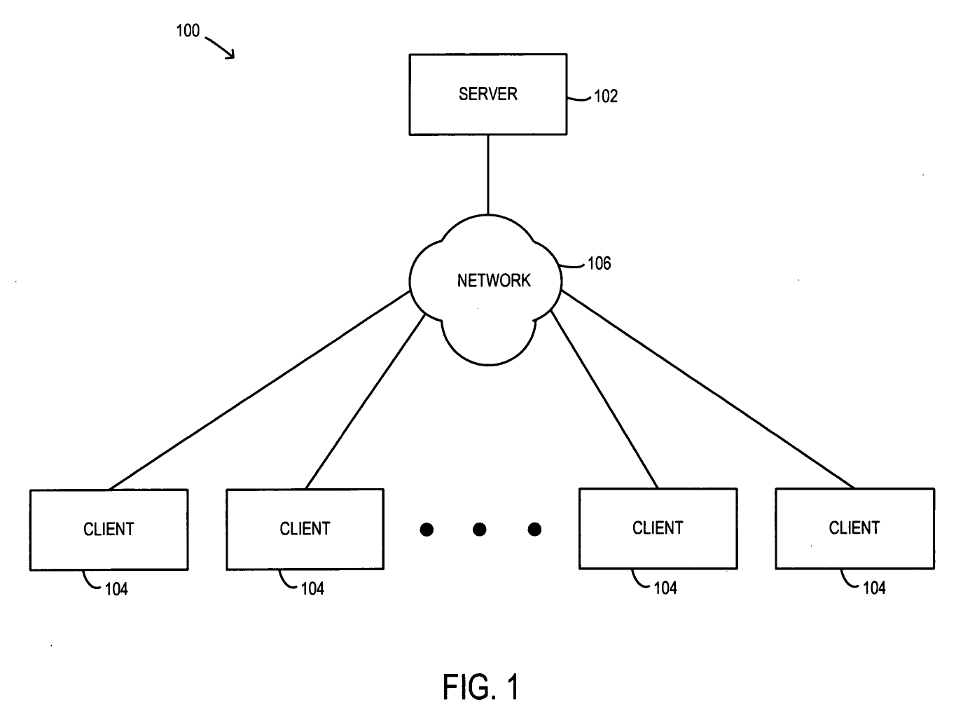

Turning now in detail to the drawings, FIG. 1 is a computer system provided according to some embodiments of the present invention. In FIG. 1, reference numeral 100 generally indicates the computer system. The computer system 100 includes a server computer 102 and a number of client computers 104. The computer system 100 also includes data communication network 106 which is coupled to the server computer 102 and to the client computers 104 to permit data communication to occur among the server computer 102 and the client computers 104. In some embodiments, the data communication network 106 may be implemented as an intranet, an extranet or a combination of intranet and extranet. In some embodiments, communication over the data communication network 106 may be performed in accordance with the well-known Internet Protocol (IP). The data communication network 106 may be physically realized with any one or more of a public network, a private network, dial-up lines or any combination thereof.

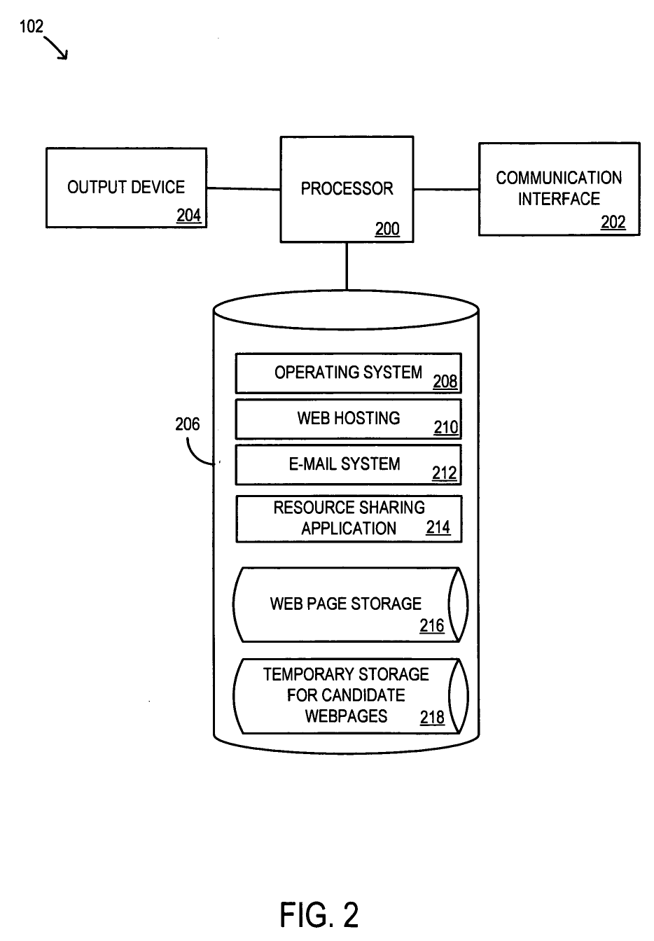

FIG. 2 is a block diagram which shows some details of the server computer 102. In its hardware aspects, the server computer 102 may be entirely conventional, or may be constructed of standard hardware components developed in the future. Moreover, the server computer may include two or more computers that are interconnected and programmed to cooperate with each other. The server computer 102 includes a processor 200, which may be a conventional microprocessor, or a number of processors operating in parallel. The processor 200 is in data communication with a communication interface 202 coupled to the data communication network 106 (FIG. 1). Continuing to refer to FIG. 2, the server computer 102 communicates with other components of the computer system 100, including the client computers 104, through the communication interface 202. The processor 200 is also in data communication with one or more output device(s) 204, which may include one or more displays and/or printers. (Although not shown in the drawing, the server computer 102 may also include one or more input devices, such as keyboards and mice, in data communication with the processor 200.)

Also included in the server computer 102 is a storage device 206, such as a conventional hard disk drive or group of hard drives, in data communication with the processor 200. The storage device 206 stores programs and data which are provided in accordance with some embodiments to control the processor 200 so that the computer system 100 operates in accordance with one or more aspects of the present invention. In particular, the storage device 206 stores an operating system 208 which controls the processor 200 to perform basic functions of the server computer 102. In addition, the storage device 206 stores web hosting software 210 which controls the processor 200 so that the server computer 102 functions to host one or more websites that are accessible by the client computers 104.

Continuing to refer to FIG. 2, the storage device 206 further stores electronic mail system software 212 so that the server computer functions as a clearing house to provide for electronic mail communication among the client computers 104. Furthermore, in accordance with some embodiments, the electronic mail system software 212 also causes the server to operate so that electronic mail communication may occur directly between the server and the client computers 104.

The storage device 206 additionally stores resource sharing application software 214 which controls the server so that the server manages access to webpages hosted by the server while also managing addition of webpages in accordance with some embodiments as described below. The application 214 may also encompass conventional webpage authoring tools.

The storage device 206 may also store data of various kinds, including the information 216 making up the webpages hosted by the server, and material 218 sent to the server in the form of e-mail attachments to be added as webpages in accordance with procedures described below.

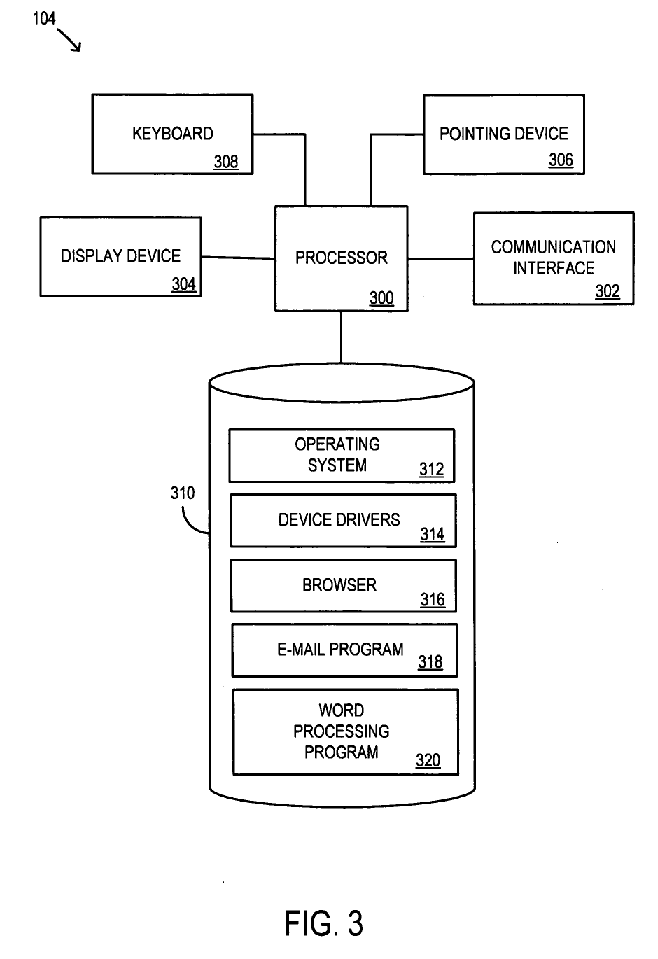

FIG. 3 is a block diagram of a typical one of the client computers 104 shown in FIG. 1. Each client computer 104 may be, in its hardware aspects, constituted in a conventional fashion as a desktop computer, a laptop computer or a notebook computer, for example. As seen from FIG. 3, the typical client computer 104 may include a processor 300 (e.g., a conventional microprocessor) and a communication interface 302 in communication with the processor 300. The communication interface 302 may allow the processor to communicate with other components of the computer system 100 (FIG. 1) such as the server computer 102 and other client computers.

Continuing to refer to FIG. 3, the client computer 104 also includes a display device 304 (e.g., a computer CRT monitor or a flat panel display) in communication with the processor 300, a pointing device 306 (e.g., a computer mouse, a track ball or a touch pad) in communication with the processor 300, and a keyboard 308 in communication with the processor 300. In addition, the client computer 104 includes a storage device 310, which may be a hard drive, for example.

The storage device 310 may store the following software: (a) an operating system 312, (b) device drivers 314 for controlling and/or receiving input from peripheral devices such as the communication interface 302, the display device 304, the pointing device 306 and the keyboard 308, (c) a browser 316 which allows the client computer 104 to operate as a client device relative to the server computer 102 (FIG. 1) and to access web pages and other server functions provided by the server computer, (d) client electronic mail software 318, and (e) a word processing program 320. In some embodiments, all of the software stored in the storage device 310 may be conventional, with all of the custom software and/or data required for the processes described below resident on the server computer 102 and accessible via standard client and e-mail software on the client computers 104.

In some embodiments, all of the client computers may be dedicated to users who are employees of a corporation that operates the computer system 100.

The server computer 102 may, but need not, be located on premises controlled by the corporation. In some embodiments, the server computer may be maintained on the premises of a contractor who provides web hosting and/or other services to the corporation, with the understanding that access to the website and webpage authoring and adding functions of the server computer 102 are limited to authorized employees or associates of the corporation. In some embodiments, the computer system 100 and/or some or all of its components may also be used for purposes besides those described herein.

“Mail-in” Webpage Feature

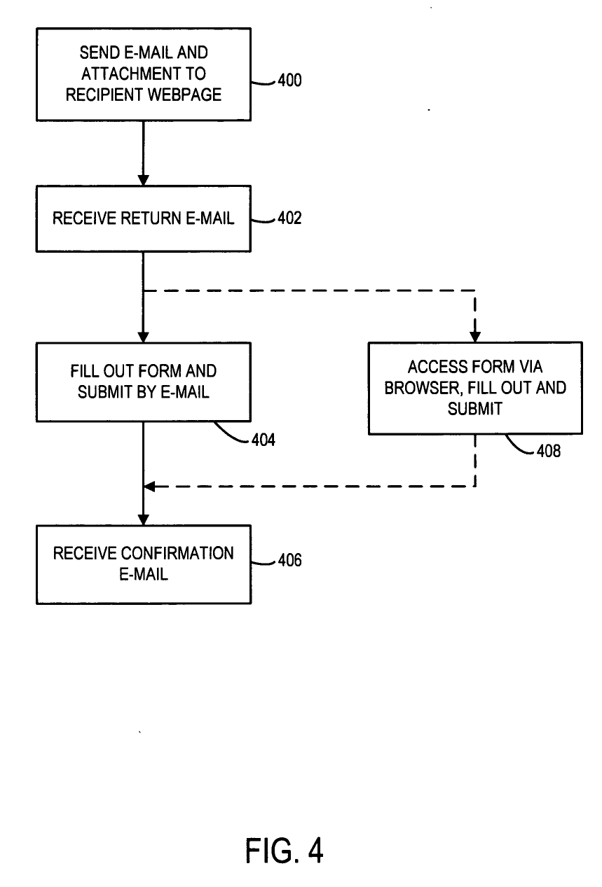

FIG. 4 is a flow chart that illustrates a procedure performed at and/or by one of the client computers 104 to add a webpage to a website hosted by the server 102.

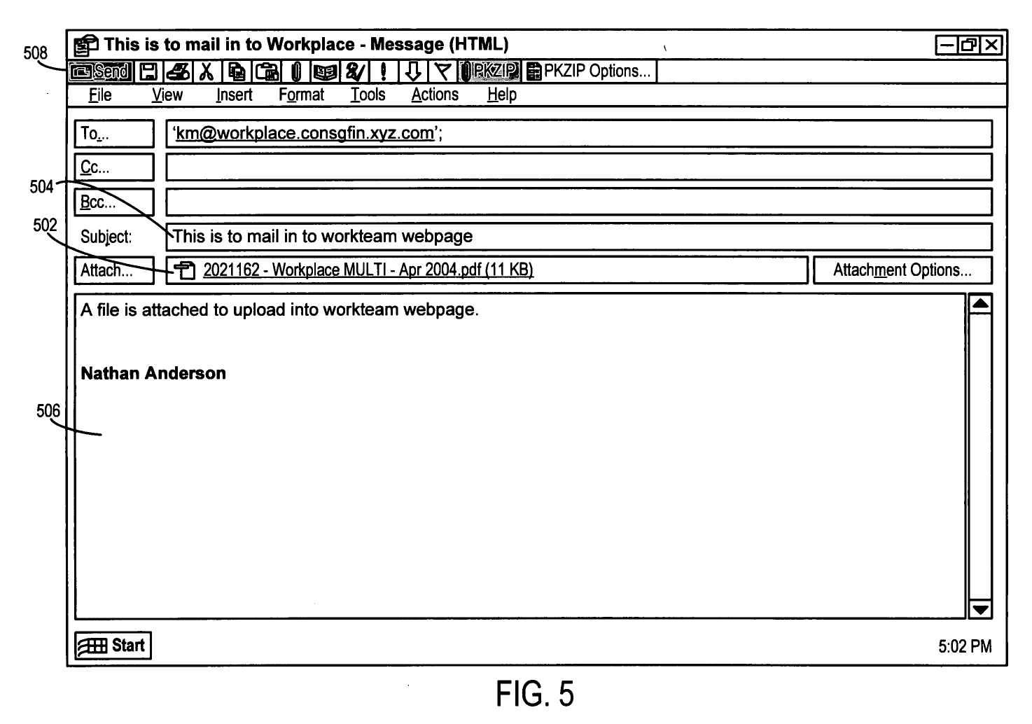

At 400 in FIG. 4, an authorized end user operates one of the client computers 104 to generate and send an e-mail message. An example of such an e-mail message is illustrated in FIG. 5. The e-mail message of FIG. 5 may be generated by using the e-mail software resident on the client computer. According to some embodiments, the user inputs as the addressee of the e-mail (or selects from a contacts list, a “To” menu or the like) an e-mail address that has been designated as a recipient address for files to be added as webpages to a particular website maintained by the server 102. In some cases, the address may correspond to a personal website maintained on the server for and by the user. In other cases, the address may correspond to a website maintained on the server for and by a workgroup of which the user is a member. The addressee website may be of other types as well.

The user may append one or more files as attachments to the e-mail message of FIG. 5 by operating the e-mail software in a conventional manner. In accordance with some embodiments, the attachments represent content which the user desires to add as one or more webpages to the website that corresponds to the recipient address. The attachment or attachments may be any type of files that may be stored on a computer hard drive, for example. Examples of the types of files that may be attached to the e-mail message of FIG. 5 are text (word processing) files, spreadsheets, digital images (e.g., color or black and white, pdf files, drawings generated by computer drawing packages), digital audio files, slides generated by computer presentation software, and so forth.

An attachment to the e-mail message of FIG. 5 is represented in conventional fashion by the icon 502 shown in FIG. 5. So-called “metadata” for the proposed webpage (i.e., explanatory and/or identification information) may be inserted into either or both of the subject line 504 and the main text field 506. Once the attachment has been appended, the e-mail message may be sent to the server 102 by actuating the “send” button 508 in a conventional manner.

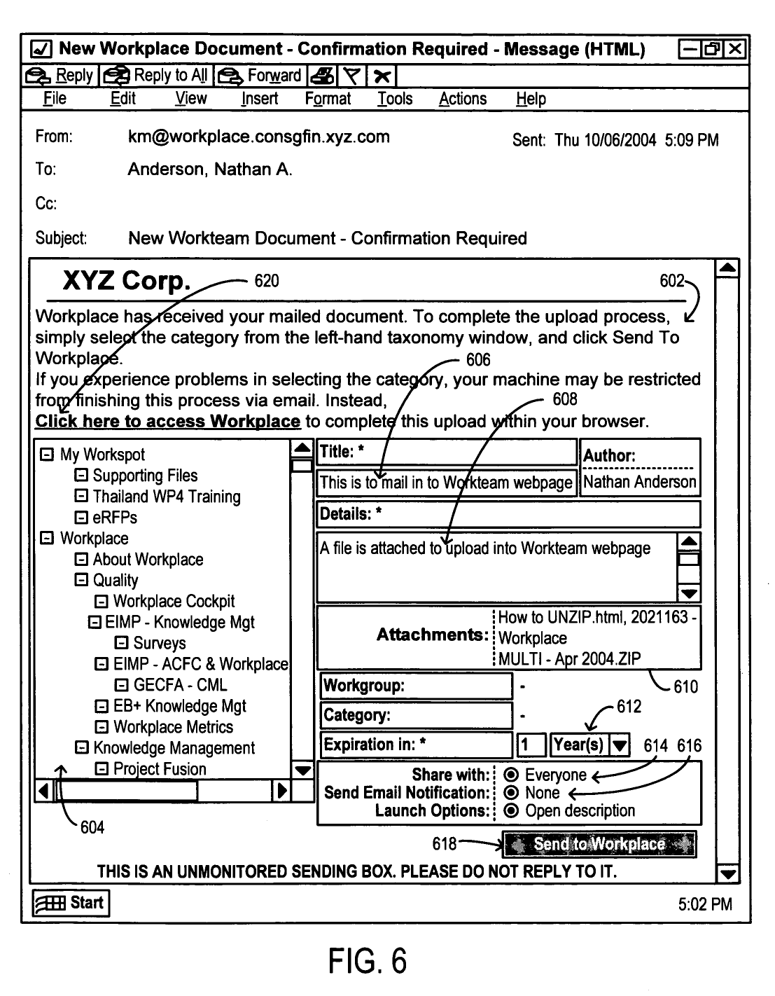

As will be seen, the server 102 automatically generates and sends to the end user who sent the e-mail message of step 400/FIG. 5 a follow-up e-mail message. An example of a follow-up e-mail message of this type is illustrated in FIG. 6. The end user may be notified of the sending of the follow-up e-mail message in a conventional manner, and may retrieve the follow-up e-mail message in a conventional manner. The end user's receipt of the follow-up e-mail message of FIG. 6 is represented at 402 in FIG. 4.

One purpose of the follow-up e-mail message is to verify the identity of the sender of the e-mail of FIG. 5. This is done simply by sending the follow-up e-mail message to the sender's registered e-mail address. If the sender responds to the follow-up e-mail address, it can be assumed that the sender, and not an impostor or “spoofer”, sent the original e-mail message with the attachment that is to be added to the website.

Another purpose of the follow-up e-mail message is to guide the sender of the original e-mail message to enter indexing information for the new webpage. Thus, as indicated at 602 in FIG. 6, the sender is instructed to select an indexing category from the “taxonomy” chart 604. In some embodiments, the title field 606 and the metadata field 608 may be editable by the sender to define the title and explanatory data to be included in the new webpage. In some embodiments, the title field 606 may initially be populated with the text from the subject field 504 (FIG. 5) of the original e-mail message, and the metadata field 608 may initially be populated with the text from the main text field 506 of the original e-mail message.

The field in the follow-up e-mail message shown at 610 in FIG. 6 indicates the name of the attachment to the original e-mail message.

Other parameters for the new webpage may either be fixed in some embodiments, though indicated in the follow-up e-mail message, or may be selectable by the sender (recipient of the follow-up e-mail message) in some other embodiments.

For example, the life-span of the new webpage may be indicated at 612, and may be selectable by the user in some embodiments.

Also, the definition of the group or groups of users who shall have access to the new webpage may be indicated at 614. In some other embodiments, a menu with “radio buttons” may be provided (e.g., as a pop-up menu which is not shown) to allow the user to select the group or groups of users who shall have access to the new webpage.

Another parameter, which may be indicated at 616, determines whether e-mail notification is to be provided upon expiration of the new webpage. This parameter too may be selectable by the user in some embodiments.

Still another parameter is the “launch option” which determines whether, upon accessing the new webpage, either just a description (e.g., title and metadata) of the page is opened, or whether the entire file is immediately opened. In some embodiments this parameter as well may be selectable by the user.

Thus the follow-up e-mail message may be considered to include a form to be filled out by the user, at least to the extent of selecting indexing information. The information inserted or selected by the user may be submitted to the server by actuating a button indicated at 618 in FIG. 6. In particular, actuation of the button 618 results in a further e-mail message being sent to the server from the user's computer with the information inserted or selected by the user in the form. Filling out of the form and submission of the information is represented by block 404 in FIG. 4.

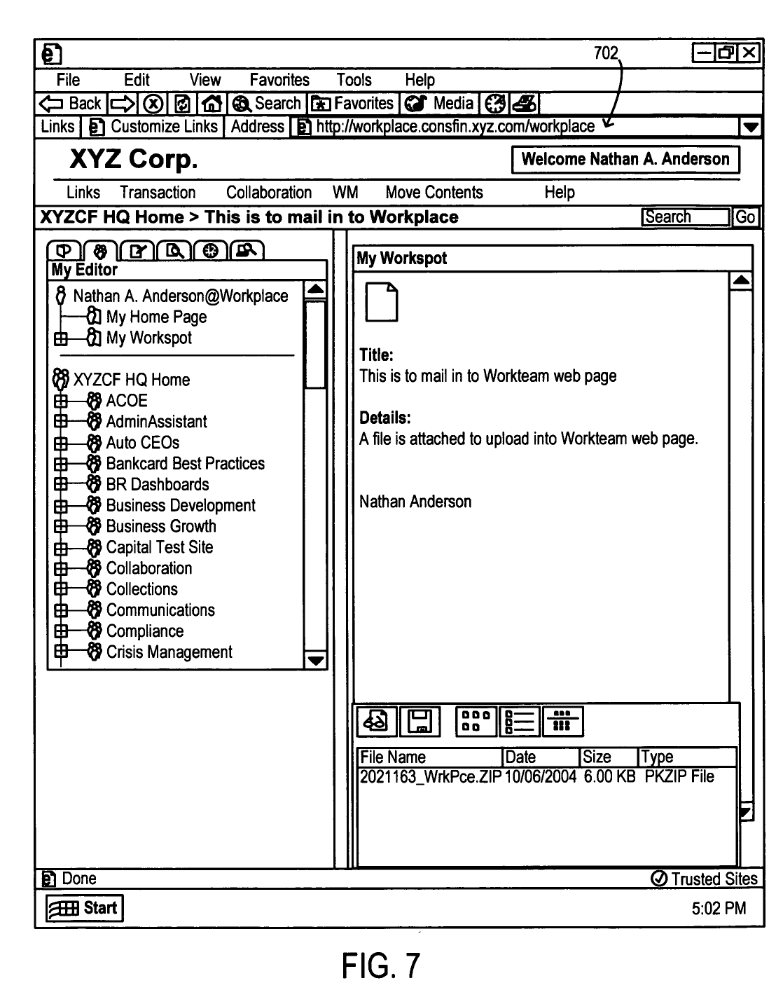

As will be seen, the server automatically responds to the e-mail message sent to it at 404 by establishing the new webpage and by sending a confirmation e-mail message to the user who sent the original e-mail message of FIG. 5 (and who received and responded to the follow-up e-mail message of FIG. 6). The user may be notified of the confirmation e-mail message and may retrieve the confirmation e-mail message by conventional operation of the e-mail software. Receiving of the confirmation e-mail message by the user is indicated by block 406 in FIG. 4. An example of a confirmation e-mail message is provided in FIG. 7. The confirmation e-mail message may include a hyperlink 702, which may be actuated to provide access to the new webpage.

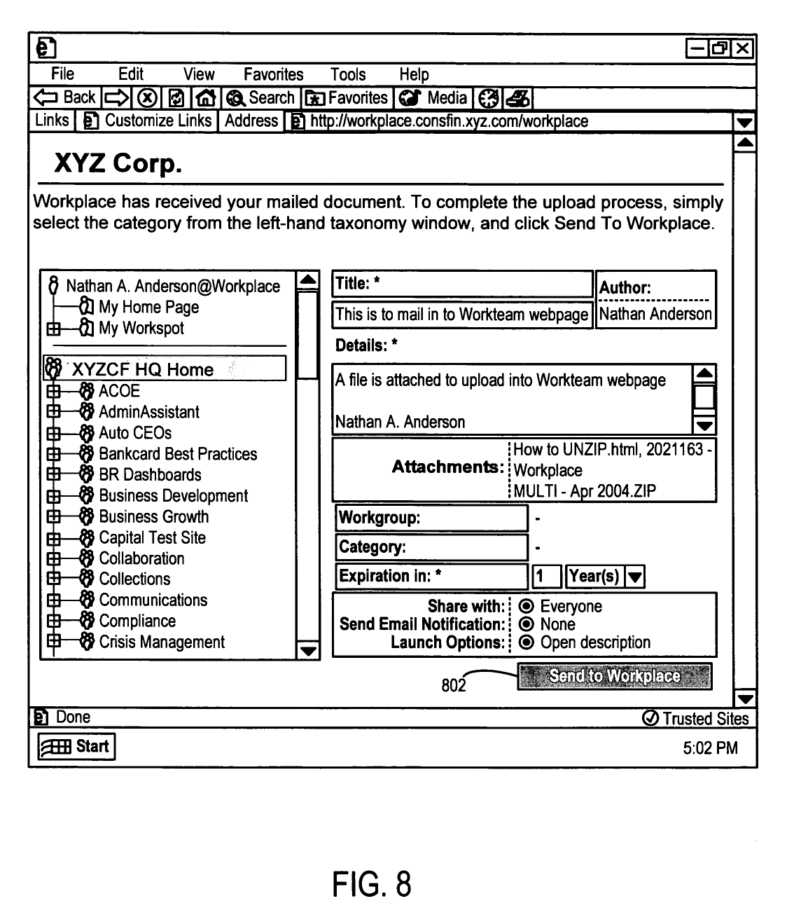

In some embodiments, security or other features of the e-mail software in the user's computer may inhibit completion of the form included in the follow-up e-mail message of FIG. 6. In such cases, the step 404 of FIG. 4 may be bypassed and the indexing information and/or other parameter information for the new webpage may be entered using the browser in the user's computer. More specifically, a hyperlink 620 (FIG. 6) may be included in the follow-up e-mail message. Actuation of the hyperlink 620 launches or activates the browser and brings up a webpage from the server such as that shown in FIG. 8. It will be observed that the webpage of FIG. 8 includes a form, similar to that of the follow-up e-mail message, which allows the user to enter/select indexing information and/or other information for the new webpage. The information entered/selected by the user may be submitted to the server by actuation of a button 802. Filling out of the form shown in FIG. 8 and submission of the information is represented by block 408 in FIG. 4. In response to submission of the indexing information and/or other information via the webpage of FIG. 8, the server may create the webpage and issue the confirmation e-mail message, as if the user had directly completed and responded to the follow-up e-mail message.

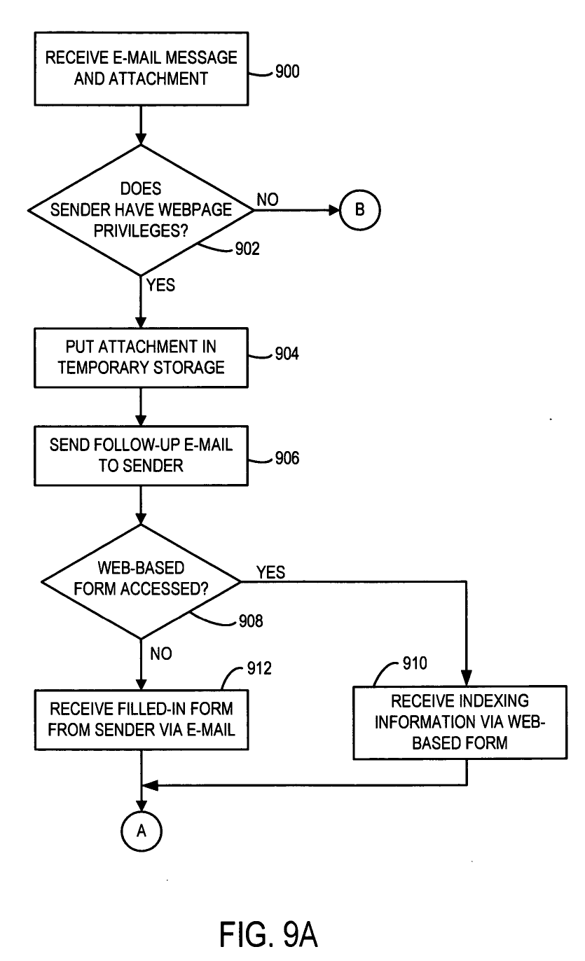

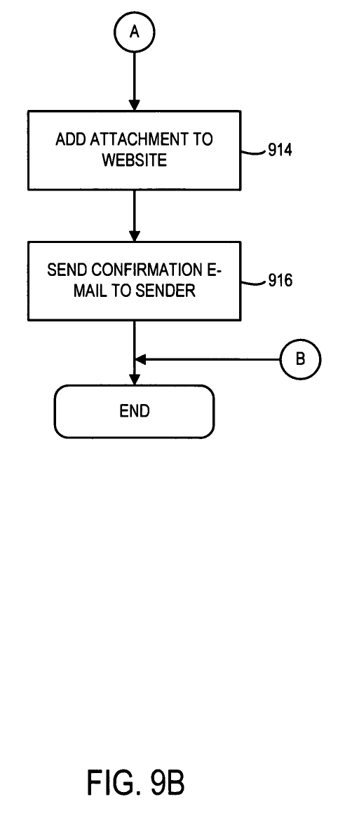

FIGS. 9A and 9B together form a flow chart that illustrates a process performed according to some embodiments by the server computer 102 in connection with the “mail-in” webpage feature previously illustrated from the user's point of view via FIGS. 4-8.

The process of FIGS. 9A and 9B starts, as indicated at 900 in FIG. 9A, with the server receiving, via an e-mail address designated for receipt of content for new webpages, an e-mail message like the message shown in FIG. 5. It will be recalled that this e-mail message includes an attachment, which is also received by the server. The server then determines, as indicated at 902, whether the sender of the e-mail message is listed among those who have the privilege of mailing in new webpage content for the website maintained by the server and which corresponds to the e-mail address to which the message was sent. If so, then, as indicated at 904, the server temporarily stores the attachment to the e-mail message. For example, the attachment may be stored in the storage facility indicated at 218 in FIG. 2, and may be indexed so as to tie the attachment to the e-mail message received at 900. Both of the actions of the server described in connection with 902 and 904 may be performed automatically in response to receiving the e-mail message and attachment at 900. As a further automatic response by the server, indicated at 906, the server sends the above-described follow-up e-mail message (illustrated in FIG. 6) to the sender of the original e-mail message received at 900. As discussed above in connection with FIG. 6, the follow-up e-mail message may include a form to be filled out by the sender of the original e-mail message to indicate indexing information and/or other information or parameters for the new webpage. As also noted above, the follow-up e-mail message may include a hyperlink (620 in FIG. 6) to allow the user to access a web-based version of the form (FIG. 8) via the user's browser.

The process of FIGS. 9A and 9B effectively branches at 908 depending on whether the user who receives the follow-up e-mail message opts to submit the indexing information and/or other information via the form in the follow-up e-mail message or via the webpage form shown in FIG. 8. It should also be noted that the server may take no further action with respect to the proposed new webpage until the user either submits the form via the follow-up e-mail message or the user actuates the hyperlink 620. In some embodiments, the server may store the attachment for a predetermined period of time such as 60 days to await a response from the user to the follow-up e-mail message and may delete the attachment from storage at the end of that time if no response is received to the follow-up e-mail message. In some embodiments the server may resend the follow-up e-mail message at regular intervals (e.g., every 14 days) until the 60 day period ends or the user responds.

In the event that the user actuates the hyperlink 620, the user's browser provides an indication to that effect to the server 102. The server responds to that indication by downloading to the user's computer a webpage of the type illustrated in FIG. 8. The user may then complete the form in the webpage of FIG. 8 via the user's browser and may submit the information to the server, possibly including indexing information for the proposed new webpage. Block 910 in 9A represents the server receiving the information submitted by the user via the form shown in FIG. 8.

Alternatively, the user may elect (if his or her e-mail software permits) to submit the indexing information, and/or other information, via the form in the follow-up e-mail message. In this case, actuation of the button 618 (FIG. 6) causes the user's computer to generate and send to the server an e-mail message which contains the information selected and/or entered by the user in the form shown in FIG. 6. In addition, the resulting e-mail message may automatically include a code to indicate to the server that the information in the e-mail message is related to the e-mail message originally received by the server at 900. Receipt by the server of the e-mail message generated by actuation of the button 618 is indicated at 912 in FIG. 9A.

In response to either receiving the e-mail message generated by actuation of the button 618 or the submission of information via the web-based form of FIG. 8, the server may automatically add (as indicated at 914, FIG. 9B) the attachment that was attached to the original e-mail message (received at 900) as a webpage to the website which corresponds to the e-mail address to which the original e-mail message was sent. The new webpage added to the website at 914 may be indexed in the website in accordance with the indexing information entered or selected by the user and received by the server at 910 or 912 (FIG. 9A). In addition, the server further responds automatically to the e-mail message received at 912 or the information submitted at 910, as the case may be, by sending the confirmation e-mail message (illustrated in FIG. 7) to the user (i.e., the sender of the original e-mail message received at 900). The sending of the confirmation e-mail message by the server is indicated at 916 in FIG. 9B. The process of FIGS. 9A and 9B is then complete.

Considering again the determination made at 902, if the sender of the e-mail message received at 900 is not found to have the privilege of adding webpages to the website that corresponds to the address to which the e-mail message was sent, then the attachment may be discarded, and the process of FIGS. 9A and 9B may end without creation of a new webpage. In some embodiments, when the sender of the original e-mail message is not authorized to add webpages to the website in question, the server may send a response e-mail message to the sender informing the sender of this fact, and that the proposed new webpage is not accepted.

In some embodiments, it is not necessary for an attachment to be included in the initial e-mail message. In such cases, the text in the subject field 504 and/or the main text field 506 may constitute the content for a proposed new webpage. The follow-up e-mail message may be issued and responded to in substantially the same manner as described in connection with FIGS. 4, 9A and 9B to confirm the sender's identity and to allow the sender to provide indexing information to the server. In some embodiments, in the absence of an attachment to the initial e-mail message, the user may be permitted to edit the title and/or metadata field (which actually correspond to the proposed new webpage content in this case) in the forms of FIGS. 6 or 8, as described above.

In some embodiments, the server may maintain more than one website and a respective “mail-in” e-mail address may be associated with each website. Moreover, some users may be authorized to add webpages to more than one of the websites. In such cases, according to some embodiments, a suitably authorized user may include two or more of the websites as addresses in a single initial e-mail message. In response to such an initial message, the server may send back to the user a separate follow-up e-mail message for each website addressee of the initial message, so that the user can enter/select separate indexing information for each of the addressee websites.

In some embodiments, the server need not be the sole addressee of the initial e-mail message. For example, in some cases the sender may indicate as a “cc” in an e-mail message (which has other, primary addressees) an e-mail address designated to receive proposed new webpages, and the process of FIGS. 9A and 9B may be initiated with the sending of such an e-mail message.

In some embodiments, the follow-up e-mail message (FIG. 6) may omit the hyperlink 620 so that the form presented by the follow-up e-mail message itself is the only vehicle for entering indexing information and verifying the sender's identity. In other embodiments, the follow-up e-mail message may omit the form shown in FIG. 6 so that accessing the webpage form (FIG. 8) is the only vehicle for entering indexing information and verifying the sender's identity.

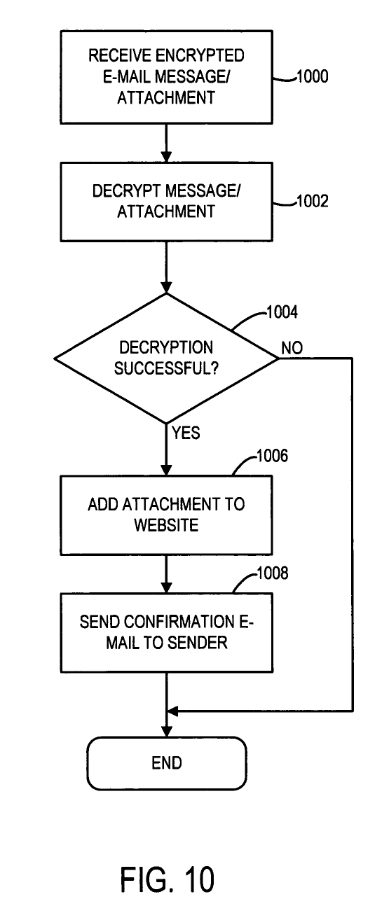

In some embodiments, encryption may be used to ensure the validity of the sender's identity instead of the exchange of e-mail messages described above. FIG. 10 is a flow chart that illustrates a process that may be performed by the server 102 in such cases.

Initially, as indicated at 1000 in FIG. 10, the server receives an e-mail message from an end user (sometimes referred to as the “sender”). The e-mail message may have an attachment, which again may be any type of file that may be stored on a hard drive, including the types of files specifically referred to above. Some or all of the e-mail message and the attachment may be encrypted by a key that is associated with the sender. The attachment may constitute content for a new webpage which the sender desires to be added to a website that corresponds to the e-mail address to which the e-mail message was sent. The e-mail message may include suitably labeled indexing information for the proposed new webpage. The e-mail message may also include title and other metadata information for the proposed new webpage.

As an automatic response to the e-mail message received at 1000, the server may decrypt or attempt to decrypt the encrypted portion (which may be the entirety) of the e-mail message and/or the attachment. This response is indicated at 1002 in FIG. 10. The decryption may be performed with a key that has previously been stored in the server and has been associated with the sender of the e-mail message. At 1004, the server determines whether the decryption was successful. If so, it may be assumed that the initial e-mail message was legitimately sent by the sender indicated in the e-mail message. Consequently, the server may automatically respond to the successful decryption by adding (as indicated at 1006 in FIG. 10) the attachment as a webpage to the website which corresponds to the e-mail address to which the original e-mail message was sent. The new webpage may be indexed in the website in accordance with indexing information that was included in the e-mail message and which the server detected by parsing the decrypted e-mail message.

The server may also respond to the successful decryption by sending (as indicated at 1008 in FIG. 10) to the sender a confirmation e-mail message. As before, the confirmation e-mail message may contain a hyperlink to provide access to the new webpage.

It should be understood that in some embodiments that utilize encryption to verify the sender's privilege to add webpages, the initial e-mail message may not have an attachment, in which case all of the content of the proposed new webpage may be included in the e-mail message itself.

With processes such as those described above, a computer system may allow a considerable number of users, potentially all users, to add webpage content to websites maintained in the computer system. The processes described herein may be very user-friendly, and may allow users to add webpages to an existing website with little or no training. At the same time, these processes may provide a reasonable degree of security to ensure that only authorized users are able to add webpage content to the website.

The present invention has the technical effect of using a computer system to facilitate creation of webpages.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method comprising:
receiving at a server computer a first electronic mail message with an attachment attached to the first electronic mail message, the first electronic mail message sent by a sender;
automatically responding to the first electronic mail message by sending to the sender from the server computer a second electronic mail message, the second electronic mail message including a form to be completed by the sender;
receiving from the sender a third electronic mail message which includes the completed form; and
automatically responding to the third electronic mail message by adding the attachment as a webpage that is part of a website maintained by the server computer.

2. The method of claim 1, wherein the webpage is indexed in the website in accordance with information contained in the completed form.

3. The method of claim 2, further comprising:
sending to the sender from the server computer a fourth electronic mail message to indicate that the attachment has been added to the website.

4. The method of claim 3, wherein the fourth electronic mail message contains a hyperlink to provide access to the webpage.

5. The method of claim 1, wherein the attachment includes at least one of a text document, a digital image and a spreadsheet.

6. The method of claim 1, further comprising:
temporarily storing the attachment until the third electronic mail message is received.

7. A method comprising:
receiving at a server computer a first electronic mail message with an attachment attached to the first electronic mail message, the first electronic mail message sent by a sender;
automatically responding to the first electronic mail message by sending to the sender from the server computer a second electronic mail message, the second electronic mail message including a first hyperlink;
receiving an indication that the sender has actuated the first hyperlink;
in response to the indication, downloading a first webpage to the sender, the first webpage including a form to be completed by the sender;
receiving indexing information entered into the form by the sender; and
automatically responding to the received indexing information by adding the attachment as a second webpage that is part of a website maintained by the server computer.

8. The method of claim 7, wherein the second webpage is indexed in the website in accordance with the received indexing information.

9. The method of claim 8, further comprising:
sending to the sender from the server computer a third electronic mail message to indicate that the attachment has been added to the website.

10. The method of claim 9, wherein the third electronic mail message contains a second hyperlink to provide access to the second webpage.

11. The method of claim 7, wherein the attachment includes at least one of a text document, a digital image and a spreadsheet.

12. The method of claim 7, further comprising temporarily storing the attachment until the indexing information is received.

13. A method comprising:
receiving at a server computer a first electronic mail message with an attachment attached to the first electronic mail message, the first electronic mail message including indexing information, at least part of the first electronic mail message and/or the attachment being encrypted, the first electronic mail message sent by a sender;
automatically responding to the first electronic mail message by decrypting the encrypted at least part of the first electronic mail message and/or the attachment using a decryption key associated with the sender;
determining whether the decrypting was successful; and
if it is determined that the decrypting was successful, automatically adding the attachment as a webpage that is part of a website maintained by the server computer.

14. The method of claim 13, wherein the webpage is indexed in the website in accordance with the indexing information included in the first electronic mail message.

15. The method of claim 14, further comprising:
sending to the sender from the server computer a second electronic mail message to indicate that the attachment has been added to the website.

16. The method of claim 15, wherein the second electronic mail message contains a hyperlink to provide access to the webpage.

17. The method of claim 13, wherein the attachment includes at least one of a text document, a digital image and a spreadsheet.

18. A computer system comprising:
a server computer;
a plurality of client computers; and
a communication network coupled to the server computer and to the client computers;
wherein the server computer is programmed to:
receive a first electronic mail message with an attachment attached to the first electronic mail message, the first electronic mail message sent by a sender;
automatically respond to the first electronic mail message by sending to the sender a second electronic mail message, the second electronic mail message including a form to be completed by the sender;
receive from the sender a third electronic mail message which includes the completed form; and
automatically respond to the third electronic mail message by adding the attachment as a webpage that is part of a website maintained by the server computer.

19. The computer system of claim 18, wherein the webpage is indexed in the website in accordance with information contained in the completed form.

20. The computer system of claim 19, wherein the server computer is further programmed to send to the sender a fourth electronic mail message to indicate that the attachment has been added to the website.

21. The computer system of claim 20, wherein the fourth electronic mail message contains a hyperlink to provide access to the webpage.

22. The computer system of claim 18, wherein the attachment includes at least one of a text document, a digital image and a spreadsheet.

23. The computer system of claim 18, wherein the server computer is further programmed to temporarily store the attachment until the third electronic mail message is received.

24. A computer system comprising:
a server computer;
a plurality of client computers; and
a communication network coupled to the server computer and to the client computers;
wherein the server computer is programmed to:
receive a first electronic mail message with an attachment attached to the first electronic mail message, the first electronic mail message sent by a sender;
automatically respond to the first electronic mail message by sending to the sender a second electronic mail message, the second electronic mail message including a first hyperlink;
receive an indication that the sender has actuated the first hyperlink;
in response to the indication, download a first webpage to the sender, the first webpage including a form to be completed by the sender;
receive indexing information entered into the form by the sender; and
automatically respond to the received indexing information by adding the attachment as a second webpage that is part of a website maintained by the server computer.

25. The computer system of claim 24, wherein the second webpage is indexed in the website in accordance with the received indexing information.

26. The computer system of claim 24, wherein the server computer is further programmed to send to the sender a third electronic mail message to indicate that the attachment has been added to the website.

27. The computer system of claim 26, wherein the third electronic mail message contains a second hyperlink to provide access to the second webpage.

28. The computer system of claim 24, wherein the attachment includes at least one of a text document, a digital image and a spreadsheet.

29. The computer system of claim 24, wherein the server computer is further programmed to temporarily store the attachment until the indexing information is received.

30. A computer system comprising:
a server computer;
a plurality of client computers; and
a communication network coupled to the server computer and to the client computers;
wherein the server computer is programmed to:
receive a first electronic mail message with an attachment attached to the first electronic mail message, the first electronic mail message including indexing information, at least part of the first electronic mail message and/or the attachment being encrypted, the first electronic mail message sent by a sender;
automatically respond to the first electronic mail message by decrypting the encrypted at least part of the first electronic mail message and/or the attachment using a decryption key associated with the sender;
determine whether the decrypting was successful; and
if it is determined that the decrypting was successful, automatically add the attachment as a webpage that is part of a website maintained by the server computer.

31. The computer system of claim 30, wherein the webpage is indexed in the website in accordance with the indexing information included in the first electronic mail message.

32. The computer system of claim 31, wherein the server computer is further programmed to send to the sender a second electronic mail message to indicate that the attachment has been added to the website.

33. The computer system of claim 32, wherein the second electronic mail message contains a hyperlink to provide access to the webpage.

34. The computer system of claim 30, wherein the attachment includes at least one of a text document, a digital image and a spreadsheet.
